(19) United States
(12) Patent Application Publication
(10) Pub. No.: US 2008/0279567 A1
(43) Pub. Date: Nov. 13, 2008

(54) ASYMMETRIC ETHERNET OPTICAL NETWORK SYSTEM

(76) Inventors: Wen Huang, Cupertino, CA (US); Fulin Pan, Fremont, CA (US); Wen Li, Fremont, CA (US); Qing Zhu, San Jose, CA (US)

Correspondence Address: XIN WEN, 3449 RAMBOW DRIVE, PALO ALTO, CA, 94306, US

(21) Appl. No.: 11/746,512

(22) Filed: May 9, 2007

(51) Int. Cl. H04B 10/00

(52) U.S. Cl. 398/168

(57) ABSTRACT

An Ethernet-based optical network system includes a first optical transmitter that can receive a first electric signal and to produce a first optical signal, a first optical receiver that can convert the first optical signal to a second electric signal. The first electric signal, the first optical signal, and the second electric signal have a first transmission baud rate. A down converter can receive a third electric signal having the first transmission baud rate and to produce a fourth electric signal having a second transmission baud rate. A second optical transmitter can receive the fourth electric signal and produce a second optical signal having the second transmission baud rate. A second optical receiver can convert the second optical signal to a fifth electric signal having the second transmission baud rate. An up converter can convert the fifth electric signal to a sixth electric signal having the first transmission baud rate.

### BACKGROUND

The present disclosure relates to Ethernet optical network technologies.

FTTX is a generic term for architecture that can provide access to user's premises, offices or remote access nodes using optical fibers. Examples of FTTX include fiber to the node (FTTN), fiber to the building (FTTB), fiber to the curb (FTTC) and fiber to the premises (FTTP). The data transmission from a central office to the user's premises, offices, or nodes is usually referred to as the downstream data transmission. Likewise, the data transmission from the user's premises, offices, or nodes to a central office is usually referred to as the upstream data transmission.

Passive optical network (PON) is attractive network architecture for the last-mile access because it does not require active components for directing optical signals between a central office and the network subscribers' terminal equipment. PON can include time division multiplexing (TDM), wavelength division multiplexing (WDM), and a combination of TDM and WDM. Time-division-multiplexing (TDM) PON is currently the primary deployment method for FTTX. TDM-PON is a point-to-multipoint architecture utilizing an optical power splitter at a remote node. TDM PON delivers downstream information through broadcasting and bandwidth sharing, and receives upstream information via time division multiple access (TDMA). Among the various competing technologies, WDM-PON has the advantage of provisioning specific wavelengths between optical line terminal (OLT) at service provider's central office and each optical network unit (ONU) at the customer's access node, which allows adjustable transmission line-speed for upstream and downstream traffics within a system.

Ethernet was initially developed as a standard local area network (LAN) access method. Ethernet has evolved from local area networks (LAN) to one of the fastest growing layer-2 protocol in wide area networks (WAN). Carrier class Ethernet has become one of the dominant protocol choices for access networks, largely driven by the economics of low-cost Ethernet chips and gears. Ethernet standard data rates are fixed at 10 megabits per second (Mbps), 100 Mbps, 1 gigabits per second (Gbps), 10 Gbps, and so on. The corresponding baud rates depend on the actual transmission type associated with coding and physical layer characteristics; Baud rate (also called Symbol rate) is the total number of the smallest unit of data transmitted per seconds on a given medium. For example, a fiber based Gigabit Ethernet transmission (1000 Base-x) transmits at a baud rate of 1250 Mbps due to its 8B/10B data coding. For a given fiber-based Ethernet link, the baud rate is fixed.

Conventional Ethernet is symmetric, that is, transmissions between two points have the same baud rates in the opposite directions. The symmetric Ethernet puts large burden on the device and equipment side especially in an access network, in which optical network units are typically operated in remote locations under uncontrolled environment. Separately, the fixed Ethernet baud rate also puts severe restriction on data rate or bandwidth each transceiver can ultimately deliver. For example, a 625 Mbps-capable transceiver can only transmit data at the maximum throughput of 100 Mbps in a conventional Ethernet system.

### SUMMARY

in a general aspect, the present specification relates to an Ethernet-based optical network system including a first optical transmitter configured to receive a first electric signal and to produce a first optical signal; a first optical receiver configured to convert the first optical signal to a second electric signal, wherein the first electric signal, the first optical signal, and the second electric signal have a first transmission baud rate; a down converter configured to receive a third electric signal having the first transmission baud rate and to produce a fourth electric signal having a second transmission baud rate lower than the first transmission baud rate; a second optical transmitter configured to receive the fourth electric signal and to produce a second optical signal having the second transmission baud rate; a second optical receiver configured to convert the second optical signal to a fifth electric signal having the second transmission baud rate; and an up converter configured to receive the fifth electric signal and to produce a sixth electric signal having the first transmission baud rate.

In yet another general aspect, the present specification relates to a Ethernet-based optical network system including a plurality of down converters each configured to receive a third electric signal having a first transmission baud rate and to produce a fourth electric signal having a second transmission baud rate lower than the first transmission baud rate; a plurality of second optical transmitters each coupled to one of the down converters, wherein one of the second optical transmitters is configured to receive the fourth electric signal and to produce a second optical signal having the second transmission baud rate; a plurality of second optical receivers each coupled to one of the second optical transmitters, wherein one of the second optical receivers is configured to convert the second optical signal to a fifth electric signal having the second transmission baud rate; and an up converter coupled to the plurality of second optical receivers, wherein the up converter is configured to receive the fifth electric signal and to produce a sixth electric signal having the first transmission baud rate.

In yet another general aspect, the present specification relates to a method of communication in an Ethernet optical network including receiving a first electric signal from a first Ethernet switch and producing a first optical signal by a first optical transmitter; converting the first optical signal to a second electric signal by a first optical receiver, wherein the first electric signal, the first optical signal, and the second electric signal have a first transmission baud rate; sending the second electric signal to a second Ethernet switch/bridge; receiving a third electric signal from the second Ethernet switch/bridge and producing a fourth electric signal by a down converter, wherein the third electric signal has the first transmission baud rate and the fourth electric signal has a second transmission baud rate lower than the first transmission baud rate; receiving the fourth electric signal and producing a second optical signal by a second optical transmitter, wherein the second optical signal has the second transmission baud rate; converting the second optical signal to a fifth electric signal by a second optical receiver, wherein the fifth electric signal has the second transmission baud rate; and receiving the fifth electric signal and producing a sixth electric signal by an up converter, wherein the sixth electric signal has the first transmission baud rate; sending the sixth electric signal to the first Ethernet switch.

Implementations of the system may include one or more of the following. The first optical transmitter, the second optical receiver, and the up converter are co-located at a first location. The Ethernet-based optical network system can further include a first Ethernet switch configured to send the first electric signal to the first optical transmitter and to receive the sixth electric signal; and a first serialization/deserialization port coupled to the first optical transmitter, the up converter; and the first Ethernet switch, wherein the first serialization/deserialization port is configured to serialize an egress electric signal from the first Ethernet switch to produce the first electric signal and to deserialize the sixth electric signal to produce an ingress electric signal to the first Ethernet switch. An input connection of the physical layer port in the first serialization/deserialization port can be integrated with the up converter. The first serialization/deserialization port and the up converter can be integrated in a unitary device. The Ethernet-based optical network system can further include a first wavelength filter coupled to the first optical transmitter and the second optical receiver; and a second wavelength filter coupled to the first wavelength filter, the first optical receiver, and the second optical transmitter, wherein the first wavelength filter is configured to route the first optical signal to the second wavelength filter and the second wavelength filter is configured to route the first optical signal to the first optical receiver, wherein the second wavelength filter is configured to route the second optical signal to the first wavelength filter and the first wavelength filter is configured to route the second optical signal to the second optical receiver, wherein the first wavelength filter and the second wavelength filter is each configured to route optical signals in a plurality of wavelength channels. The first optical transmitter and the first optical receiver can operate in the same wavelength channel. The second optical transmitter and the second optical receiver can operate in the same wavelength channel. The first optical receiver, the second optical transmitter, and the down converter can be co-located at a second location. The Ethernet-based optical network system can further include a second Ethernet switch/bridge having an egress port configured to send the third electric signal at the first transmission baud rate to the second optical transmitter, and having an ingress port configured to receive the second electric signal also at the first transmission baud rate. The Ethernet-based optical network system can further include a second serialization/deserialization port coupled to the first optical receiver, the down converter, and the second Ethernet switch/bridge, wherein the second serialization/deserialization port is configured to serialize an egress electric signal from the second Ethernet switch/bridge to produce the third electric signal for the down converter and deserialize the second electric signal from the first optical receiver to produce an ingress electric signal to the second Ethernet switch/bridge. An input connection of the physical layer port in the second serialization/deserialization port can be integrated with the down converter. The second serialization/deserialization port and the down converter can be integrated in a unitary device. The second transmission baud rate can be adjusted by one or more external control signals received by the down converter, the up converter, and the second Ethernet switch/bridge. The first transmission baud rate can be selected from a group corresponding to data rate of 10 Mbps, 100 Mbps, 1 Gbps, 2 Gbps, 4 Gbps, 5 Gbps, 10 Gbps, and so on. The second transmission baud rate can be in the range of less than the first transmission baud rate. The first optical transmitter can include DFB laser, Fabre-Perot laser or wavelength tunable laser. The second optical transmitter can include ASE source, a Fabre-Perot laser, a DFB laser or a wavelength tunable laser.

Embodiments may include one or more of the following advantages. The disclosed systems and methods can be compatible with Ethernet standard while providing flexibility and simplicity for optical communications, which allows standard, off-the-shelf, and low-cost components to be used in the disclosed system. For example, the disclosed system can readily be implemented by two standard Ethernet switches or bridges from multiple commercial sources to lower the overall system cost.

The disclosed systems and methods can provide asymmetric communications having different baud rates between two opposite directions within a dedicated Ethernet link. The different baud rates also correspond to different data rates, which is commonly referred to as bandwidth asymmetry. For example, to be compatible with most FTTX applications, upstream optical transmission baud rates can be set at lower than that of the downstream baud rates in the disclosed systems. Lower speed and thus lower-cost optical transceivers can be used especially at remote ONU for upstream communications, regardless of the speed of optical transceivers at OLT for downstream communications.

Moreover, the disclosed systems and methods can also better match the bandwidth requirements and usage patterns in today's access network systems. Asymmetric Digital Subscriber Loop (ADSL), for example, is intrinsically asymmetric in the bandwidth requirements with downstream to upstream bandwidth ratio larger than 1 (ADSL2+ today has a ratio of ˜20). For an Ethernet communication system: to backhaul the ADSL data, forcing the symmetric baud rate will undoubtedly increase system and component costs and left with excess upstream bandwidth that could not be utilized by the networks. Instead, the upstream optical transmission baud rate can be tailored in the disclosed systems to match the need for upstream data rate (bandwidth) requirements with the benefits of deploying low-cost component.

The cost impact of symmetric Ethernet transmission in a WDM optical network is especially severe due to the requirements of controlling and stabilizing the working wavelength of the transmitter at remote ONU, which is operating in an uncontrolled environment. The lower baud rate for the upstream transmission allow low-cost amplified spontaneous emission (ASE) sources such as light-emitting diode (LED), super-luminescent light-emitting diode (SLED) etc., to be adequately used in the ONU.

The disclosed system can better harness the transceiver capabilities by allowing an intermediate baud rate to be used between the standard Ethernet transmission baud rates. For example, a 625 Mbps baud rate transmitter can deliver up to its full capacities of data transmission in an otherwise rigid, unforgiving Ethernet environment, wherein the baud rates are spaced by approximately a factor of 10.

Furthermore, the disclosed system and methods could allow upstream baud rate and thus the data transmission rate to be adjusted through remote software configuration or even dynamically provisioned to match the medium and physical conditions of the optical transceivers. It is in sharp contrast to the fixed transmission baud rates at either 125 Mbps, 1.25 Gbps or 10.3125 Gbps in conventional Ethernet systems with 100 Mbase-X, 1 Gbase-X and 10 Gbase-R physical layer implementation respectively.

Although the specification has been particularly shown and described with reference to multiple embodiments, it will be understood by persons skilled in the relevant art that various changes in form and details can be made therein without departing from the spirit and scope of the specification.

### BRIEF DESCRIPTION OF THE DRAWINGS

FIG. 1 is a block diagram for a conventional Ethernet-based optical network system including a symmetric link over a point-to-point connected OLT and ONU.

FIG. 2 is a block diagram of an Ethernet-based optical network, system having asymmetric upstream and downstream optical transmission rates in accordance with the present specification.

FIG. 3 is a block diagram of an exemplified down converter suitable for the Ethernet-based optical network system of FIG. 2,

FIG. 4 is a block diagram of an exemplified up converter suitable for the Ethernet-based optical network system of FIG. 2,

FIG. 5 is a block diagram of another implementation of an Ethernet-based optical network system having asymmetric upstream and downstream optical transmission rates in accordance with the present specification.

FIG. 6 illustrates an exemplified optical Ethernet system over a WDM-PON.

### DETAILED DESCRIPTION

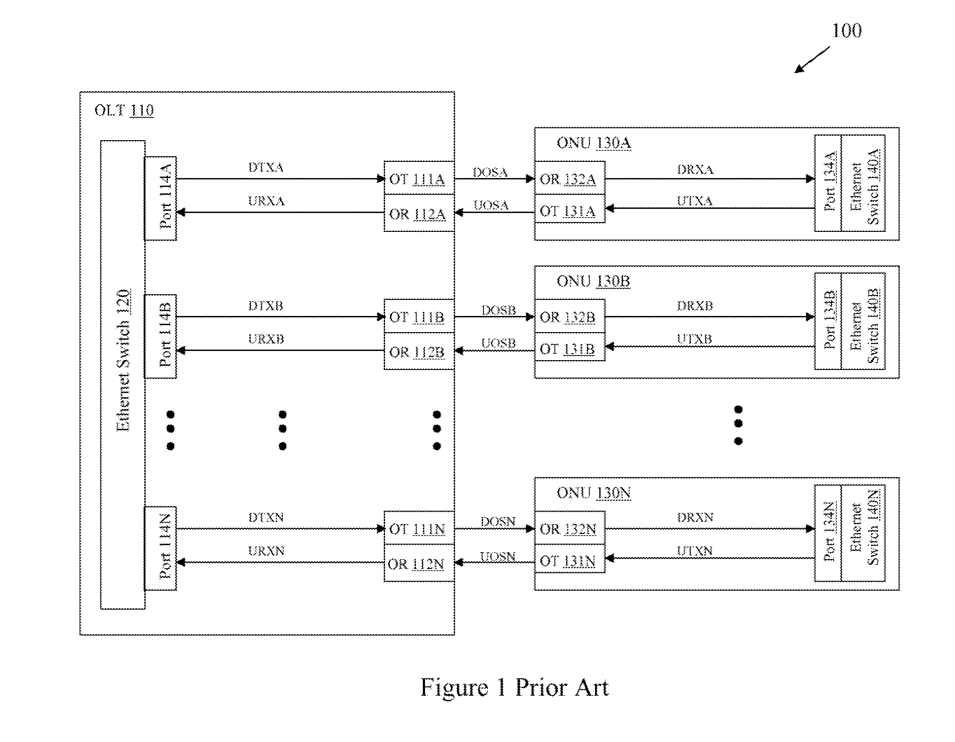

Referring to FIG. 1, a conventional Ethernet-based optical network system 100 includes an OLT 110 and a plurality of ONUs 130A-130N. The OLT 110 includes an Ethernet, switch 120, for example, a gigabit Ethernet switch (GE), and a plurality of SerDes ports 114A-114N each adapted to communicate with the plurality of ONUs 130A-130N in a different channel. SerDes port refers to an Ethernet switch port having integrated optical PHY layer circuit that allows an optical transceiver to be directly connected. The port 114A is connected with an optical transmitter (OT) 111A and an optical receiver (OR) 112A, respectively for sending optical signals to and receiving optical signals from the ONU 130A in the specific channel associated with the port 114A. The corresponding ONU 130A can include an optical receiver (OR) 132A for receiving downstream optical signals from the OT 111A and an optical transmitter (OT) 131A for sending upstream optical signals to OR 112A. The OR 132A and OT 131A are connected with a port 134A that is in turn connected with a second Ethernet switch (or bridge) 140A, for example, a fast Ethernet switch (FE).

Similarly, ports 114B . . . 114N are respectively connected with OT 111B-111N and OR 112B-112N for communicating with ONUs 130B-130N in their respective channels. Each pair of OT 111B/OR 112B . . . OT 111N/OR 112N is connected with a pair OT 131B/OR 132B . . . or OT 131N/OR 132N in the associated ONU 130B-130N. Each pair OT 131B/OR 132B . . . or OT 131N/OR 132N is connected with a SerDes port 134B . . . or 134N in the associated ONU 130B . . . or 130N.

The transmission baud rates in the conventional Ethernet-based optical network system 100 are intrinsically symmetric in the upstream and downstream directions. For instance, the ports 114A-114N are required to have the same transmission baud rate for output electric signals DTXA-DTXN and input electric signals URXA-URXN, for example, all at 1.25 gigabits per second (Gbps). Similarly, at the ports 134A-134N, the input electric signals DRXA-DRXN and output electric signals UTXA-UTXN also operate at the same transmission baud rate, for example, 1.25 (Gbps). Consequently, the downstream optical signals DOSA, DOSB . . . DOSN from OT 111A to OR 132A, from OT 111B to OR 132B . . . and from OT 111N to OR 132N respectively have the same transmission baud rates of 1.25 Gbps. The upstream optical signals UOSA, UOSB . . . and UOSN from OT 131A to OR 112A, from OT 131B to OR 112B . . . and from OT 131N to OR 112N respectively also have the same transmission baud rates of 1.25 Gbps.

One drawback of the conventional Ethernet-based optical network system 100 is that the OT 131A-131N at ONUs 130A-130N have to operate at the same transmission baud rates as that of the OT 111A-111N at the OLT 110. High baud rate optical transmitters with similar or even more stringent performance specifications as that of the ones in OLT have to be deployed in order to maintain the symmetric transmission baud rate. Access equipments are very cost sensitive, especially with all the transmitters distributed at various ONUs in the field and operating under uncontrolled environments.

In a DWDM based passive optical network system—WDM-PON, requiring symmetric baud rate in a system essentially forces all the transmitters OT 111A-111N in OLT and OT 131A-131N in ONU to operate at the same high-speed baud rate. It is very challenging and costly to precisely control the ONU wavelength to fit the specific channel wavelength of the corresponding WDM port if single/discrete wavelength transmitters such as distributed-feedback (DFB) or Fabre-Perot lasers are to be used. Allowing asymmetric baud rate in the Ethernet link, the upstream transmitters OT 131A-131N can be implemented with low-cost, uncooled amplified spontaneous emission (ASE) sources such as LED or SLED, which are typically modulated at speed below 1.25 Gbps today.

On the other hand, for most FTTX applications, the network bandwidth requirements are asymmetric. Most of the bandwidth intensive applications such as IPTV, video and data download relies heavily on the downstream bandwidth. Some of the pier-to-pier applications and video conferencing requires symmetric bandwidth. Only those applications such as web and service hosting require excessive, of upstream bandwidth. In a naturally asymmetric network, symmetric upstream and downstream optical transmissions baud rate means that, most of the time, the upstream optical transmitters OT 131 A . . . or OT 131N are sending idle code-groups in the conventional Ethernet-based optical network system 100.

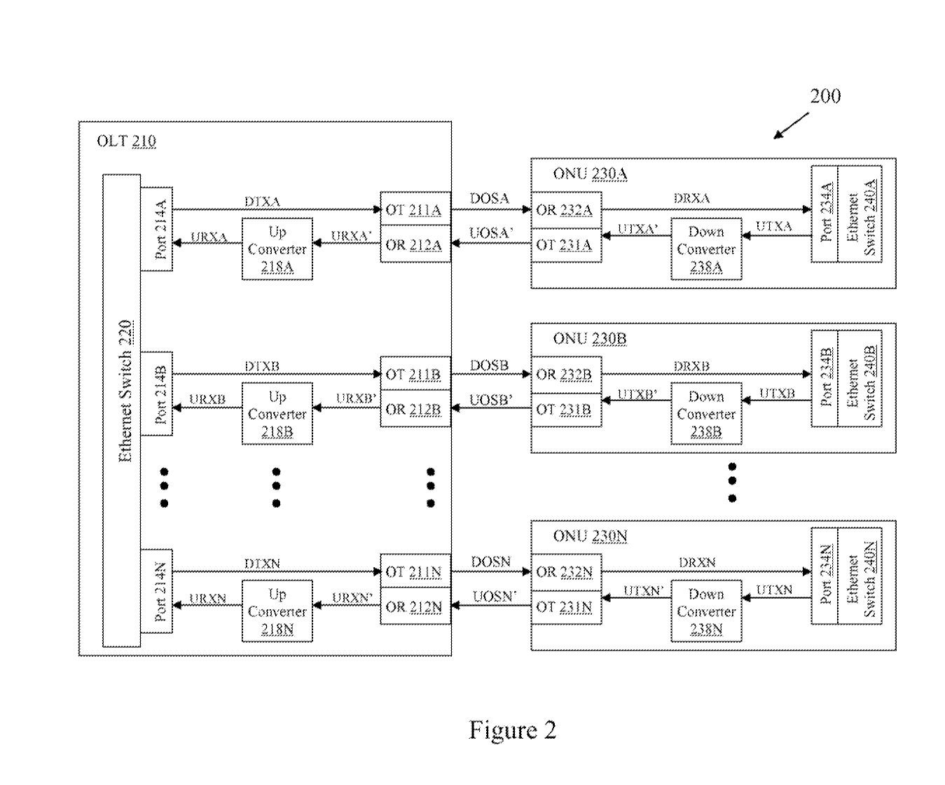

An Ethernet-based optical network system 200 is disclosed in the present specification to overcome the various drawbacks in the convention Ethernet-based optical network systems. Referring to FIG. 2, an Ethernet-based optical network system 200 can include an OLT 210 and a plurality of ONUs 230A-230N. The OLT 210 can include a Ethernet switch 220, for example a gigabit Ethernet (GE) switch and a plurality of SerDes ports 214A-214N each adapted to communicate with the plurality of ONUs 230A-230N in a different channel. For example, the port 214A is connected with an OT 211A and an OR 212A, respectively for sending optical signals to and receiving optical signals from the ONU 230A in the specific channel associated with the port 214A. The corresponding ONU 230A can include an OR 232A for receiving downstream optical signals from the OT 211A and an OT 231A for sending upstream optical signals to OR 212A. The OR 232A and OT 231A are connected with a SerDes port 234A that is in turn connected with another Ethernet switch/bridge 240A, for example a Fast Ethernet (FE) switch.

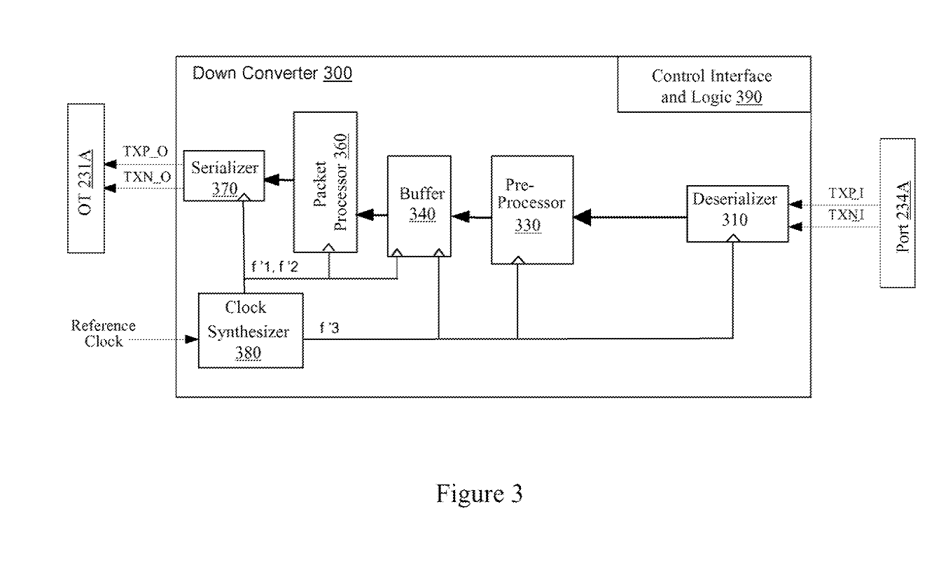

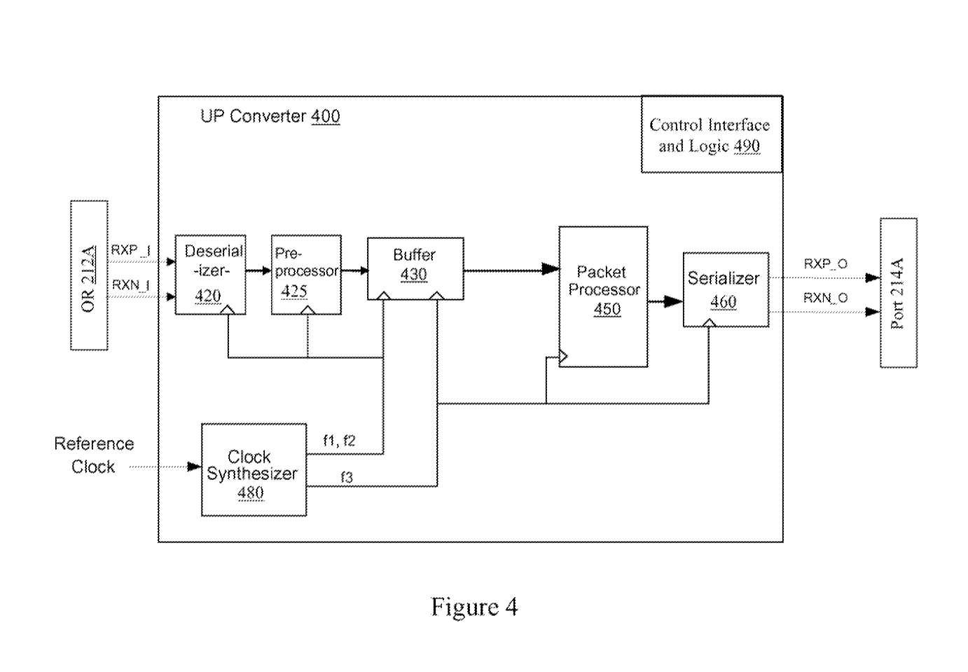

The Ethernet switch 220 can have layer 2, 3 or above switching functions with multiple 1 Gbps (data rate) ports and with one or more uplink ports at data rates of 1 Gbps or 10 Gbps, which is available as application specific integrated circuits (ASIC) from many commercial vendors. One of the port 214A's functions is to convert the parallel data signals from the GE switch 220 to a serial electric data signal DTXA. The serialization converts a parallel single-ended signal to a differential signal pair (which is a convention for signal transmissions in optical Ethernet physical layer. See FIGS. 3 and 4 for more details). The port 234A can convert the serialized electric signal DRXA from the OR 232A to parallel data format. The deserialization can convert the differential signal pair to a parallel single-ended signal. The Ethernet switch/bridge 240A is a layer 2 or above Ethernet switch/bridge that can include multi-ports 10/100/1000 Mbps data rate further downlink ports and one or more uplink ports at 1 Gbps data rate, which is also commercially available from many vendors.

Conventional Ethernet systems require the transmission baud rates between the ports 214A-214N and at the ports 234A-234N to be symmetric in the output and input directions. Specifically, the transmission baud rates of the electric signal DTXA, DRXA and the electric signal URXA, UTXA are the same at the port 214A and 234A. Similar symmetric requirements hold for the other communication ports 214B and 234B . . . 214N and 234N. For example, the electric signal transmissions at the ports 214A-214N and at the ports 234A-234N can operate at the same baud rate, such as 1.25 Gbps in both downstream and upstream directions. The Ethernet-based optical network system 200 can also include a plurality of down converters 238A-238N in different ONUs 230A-230N and a plurality of up converters 218A-218N that are always working in pair. The down converter 238A can receive a first electric signal UTXA from the port 234A and produce a second electric signal UTXA′ at a decreased transmission band rate. For example, if the first electric signal is at 1.25 Gbps transmission baud rate, the transmission baud rate for the second electric signal can be reduced to less than 1.25 Gbps. The second electric signal having the lower transmission baud rate is sent to OT 231A. The OT 231A converts the electric signal UTXA′ with the reduced transmission baud rate to an optical signal UOSA′ with the same transmission baud rate as that of UTXA′ and send it to the OR 212A at the OLT 210. The OR 212A then converts the optical signal UOSA′ into a third electric signal URXA′, which is running at the same reduced baud rate as that of UTXA′. The up converter 218A can convert the third electric signal URXA′ with the reduced transmission baud rate to a fourth electric signal URXA at the original 1.25 Gbps transmission baud rate. Thus the port 214A can output an electric signal DTXA at 1.25 Gbps baud rate and input an electric signal URXA at the same baud rate (1.25 Gbps) as required by Ethernet standard. The down converters 238B-238N and the up converters 218B-218N operate in an opposite fashion, which end up with the same baud rate as the original signal.

In some embodiments, the up converters 218A (or 218B-218N) and the port 214A (or 214B-214N) for each channel can be integrated in a unitary device to reduce footprint and cost. The down converters 238A (or 238B-238N) and the port 234A (or 234B-234N) at the ONU 230A can also be integrated in a unitary device.

It is important to point out that by reducing the transmission baud rates from OT 231A-231N to OR 212A-212N, the data rate (bandwidth), more specifically the peak information rate (PIR) have to be reduced at the Ethernet switch/bridge 240A-240N accordingly to ensure normal flow of data packet without loss of information. In a simple implementation that maintaining the same coding scheme, the ratio of bandwidth can be equal to the ratio of baud rate. For example, a bandwidth 1 Gpbs Ethernet port with a baud rate of 1.25 Gbps can be reduced to 500 Mbps (bandwidth) with a baud rate of 625 Mbps.

The transmission baud rates for the upstream optical signals can be less than the downstream transmission baud rate. An exemplified upstream baud rate reduction factor can be from 0.01 to 0.99. A special case of no baud rate reduction (simply a bypass mode) can also be implemented in these up/down converters. Another implementation allows reduced transmission baud rates of the upstream optical signals to be corresponding to an increment of 50 Mbps in the data rate, i.e. 50 Mbps, 100 Mbps, 150 Mbps, 200 Mbps . . . 900 Mbps, 950 Mbps etc. The disclosed systems and methods can also be compatible with various different, designs of up converters and down converts for Ethernet-based optical system.

Optical transmitters OT 231A-231N operating at lower transmission baud rates can be significantly simpler and less expensive than those optical transmitters operating at transmission baud rate 1.25 Gbps or above. The optical transmitters OT 231A-231N can advantageously be compatible with low-cost, uncooled broad-spectrum amplified spontaneous emission (ASE) sources such LED or SLED to be used as optical transmitters. These ASE sources typically operate at speed below 1.25 Gbps without any costly temperature-control device. It is also a key enabler for cost effective implementation of WDM-passive optical network for broadband access.

Referring to FIG. 3, a down converter 300 suitable for the down converters 238A-238N in the Ethernet-based optical network system 200 can include a deserializer 310, a pre-processor 330, a buffer 340, a packet processor 360, a serializer 370, a clock, synthesizer 380, and a control interface and logic 390. In asymmetrical communication, the Ethernet switch/bridge 240A at Port 234A can be configured to perform traffic shaping to limit the upstream data rate (bandwidth) to below the downstream data rate in accordance with the specific reduction factor of the transmission baud rate.

In some embodiments, the transmission baud rate for the upstream optical signals can be adjusted by control signals sent to the Ethernet switch/bridge 240A, the up converter 238A, and the down converter 218A. The control signals can be sent remotely from a central office. The upstream transmission baud rate for the optical signals can thus be conveniently controlled and dynamically changed.

The electrical interface of the port 234A can be a pair of differential signals TXP_I and TXN_I running at the original signal baud rate (1.25 Gbps). The pair of differential signals TXP_I and TXN_I in combination forms the upstream electric signal UTXA (FIG. 2) from the port 234A to the down converter 300 (or 238A). The deserializer 310 is used to convert the differential signal TXP_I and TXN_I to a parallel signal, and send the parallel signal to the pre-processor 330. The pre-processor 330 performs three basic functions: 1) to identify the data frame, which can be done by sorting out the Start of Frame Delimiter (SFD) and the End of Frame Delimiter (EFD); 2) to identify the Ethernet control code-groups; and 3) to filter out the idle code-groups, which are a set of special codes in the Ethernet data stream acting as a padding between data frames to maintain a constant transmission baud rate. The processed data frames and control code-groups from pre-processor 330 are then sent to the buffer 340. The buffer 340 is configured to have enough memory to store long Ethernet data frame according to the design specifications. The output of the buffer 340 is sent to the packet processor 360. The buffer receives and stores the Ethernet data frames and the control code-groups from the pre-processor 330 at a specific processing speed and further sends it to the packet processor 360 at another (lower) specific processing speed. The packet processor 360 can also insert Ethernet idle code-groups between the data frame and other optional code-groups for control, redundancy and link integrity check etc. The purpose for the packet processor 360 to insert Ethernet idle code-groups between the data frames is to maintain its specified output baud rate when the actual data rate drops below its specified maximum data rate (bandwidth). The packet processor 360 can also maintain the DC balance of its output signal. The output of the packet processor 360 is sent to the serializer 370 where the parallel data is converted to differential signals TXP_O and TXN_O to be sent to the optical transmitter 231A. The pair of differential signals TXP_O and TXN_O together forms the upstream electric signal UTXA′ (FIG. 2) from the down converter 300 (or 238A) to the OT 231A.

The clock synthesizer 380 is used to generate necessary reference clock signals from an input reference clock signal. The control interface and logic 390 is used for the down converter 300 to interface with a microprocessor and configuration pins. The microprocessor interface can be standard parallel or serial interface, such as an Intel or a Motorola CPU bus, SPI and 12C bus. The microprocessor and configuration pins can configure the down converter 300 to operate at a specific baud rate (in this example, less than 1.25 Gbps). The clock synthesizer 380 can also produce clock signals at frequencies in accordance with the specified baud rate.

Referring to FIG. 4, an up converter 400 compatible with the up converters 218A-218N in the Ethernet-based optical network system 200 can include a deserializer 420, a pre-processor 425, a buffer 430, a packet processor 450, a serializer 460, a clock synthesizer 480, and a control interface and logic 490. The input signal URXA′ to the up converter 400 or 218A can be a pair of differential signals RXP_I and RXN_I. The deserializer 420 can convert the serialized differential signal RXP_I and RXN_I to a parallel data. The pre-processor 425 is used to sort out the idle code-groups, the control code-groups and the data frames before storing into the buffer 430. The buffer 430 is con figured to have enough memory to store long Ethernet data frame and necessary code-groups according to the design specifications. The output of 430 is sent to the packet processor 450. The buffer 430 receives and stores the data frames and control code-groups from the pre-processor 425 at a specific processing speed. The buffer 430 further sends it to a packet processor 450 at another (higher) specific processing speed. In order to maintain the transmission baud rate of the output of the serializer 460 at a constant and a higher baud rate, the packet processor 440 performs necessary tasks of inserting idle code-groups between data frames or control code-groups to raise the transmission baud rate back to the original baud rate (e.g. at 1.25 Gbps for a GE link). The packet processor 450 also maintains its output at a desirable DC balance. The packet processor 450 can output parallel data stream and to send them to the serializer 460. The serializer 460 converts the parallel data stream to a pair of differential signals RXP_O and RXN_O, which are to be received by the port 214A of the OLT. The pair of differential signals RXP_O and RXN_O together forms the upstream electric signal URXA from the up converter 218A to the port 214A.

The clock synthesizer 480 can provide necessary reference clock signals from an input reference clock signal. The control interface and logic 490 is used for interfacing with a microprocessor and configuration pins. The microprocessor interface can be standard parallel or serial interface, such as an Intel or a Motorola CPU bus, SPI and 12C bus. The microprocessor and configuration pins can configure the up converter 400 to take the incoming signal from the down converter at a specific lower transmission baud rate back to the original baud rate for any standard Ethernet switch.

It is understood that the above described down converter 300 and up converter 400 are suitable to one or more down stream and up stream converters in other channels.

One of the advantages of the disclosed system is that the upstream optical transmission baud rate can be adjusted by software configuration of the down converter 300, the up converter 400 and the Ethernet switch/bridge (240A-240N) data rate simultaneously through the control interface and logic 390/490. In some embodiments, the adjustment of the upstream transmission baud rate can be accomplished remotely by sending a control signal to the control interface and logic 390/490 from a central office or a remote ONU node.

In some embodiments, the down converter 238i and the physical layer egress (output) port of the port 234i can be integrated, where i=A . . . N. The up converter 218i and the physical layer ingress (input) port of the port 214i can be integrated, where i=A . . . N. Such implementation is far more efficient and economical since many of the redundant functions such as serialization, deserialization, clock synthesis, idle code-groups addition and removal etc., can all be combined. In other words, down converter 238i and up converter 218i can be directly implemented in the physical coding sublayer defined in IEEE 802.3.

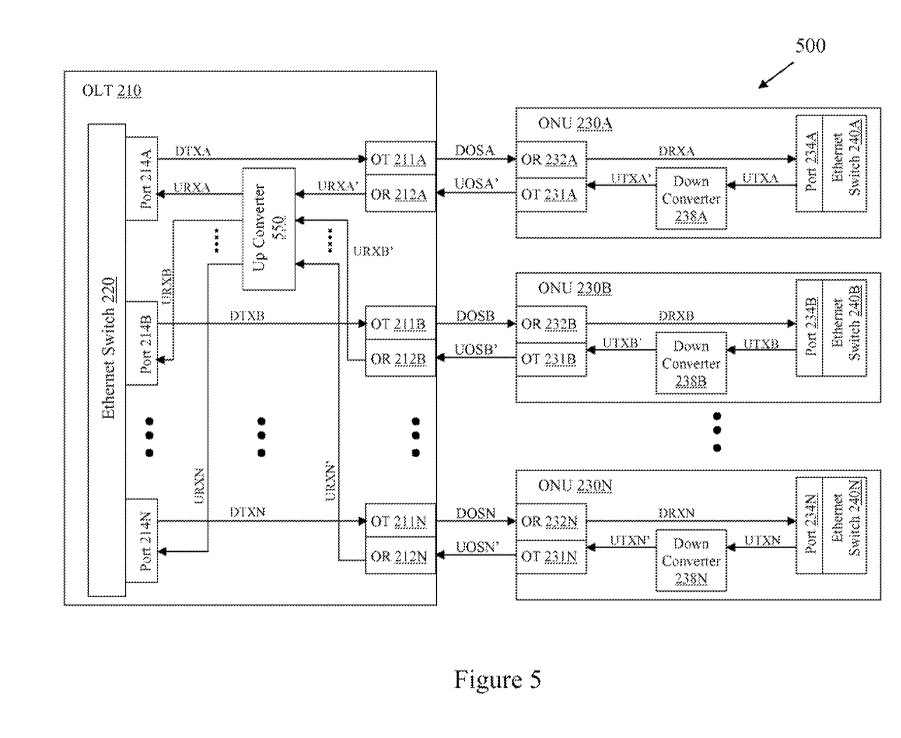

In other embodiments, the up converters 218A-218N in the OLT 210 can be combined into a single multi-channel up converter circuit. Referring to FIG. 5, an Ethernet-based optical network system 500 can include a multi-channel up converter 550 for up converting transmission baud rates of the upstream electric signals in different channels at the OLT 210. Other components and their operations in the Ethernet-based optical network system 500 can be similar to their counterparts in the Ethernet-based optical network system 200.

The OR 212A receives an upstream optical signal UOSA′ at a lowered transmission baud rate (less than 1.25 Gbps) and outputs an electric signal URXA′ at the same transmission baud rate. The up converter 550 receives the electric signal URXA′ at the lowered transmission baud rate and converts it to electric signal URXA at the original transmission baud rate (1.25 Gbps). Similarly, the up converter can convert electric signals URXB′ . . . URXN′ at lowered transmission baud rates from OR 212B . . . OR 212N respectively back to electric signals URXB . . . URXN at the original transmission band rates (1.25 Gbps) in their respective channels. The conversion process in the up converter 550 for each channel can operate similarly to the previously describe operations for the single-channel up converter 400.

The multi-channel up converter is more cost effective and more compact than separate single-channel up converter for individual channels. Several components (for example, power supply, clock synthesizer, etc.) can be shared between different channels in the multi-channel up converter. The up converter 550 can therefore further reduce complexity, cost and footprint for Ethernet-based optical network system.

The down converter 300, the up converter 400, and the multi-channel up converter 550 can be implemented as a field programmable gate array (FPGA), an application specific integrated circuit (ASIC), a digital signal processor (DSP), general-purpose computer processor, network processor, discrete components or any of the combinations above.

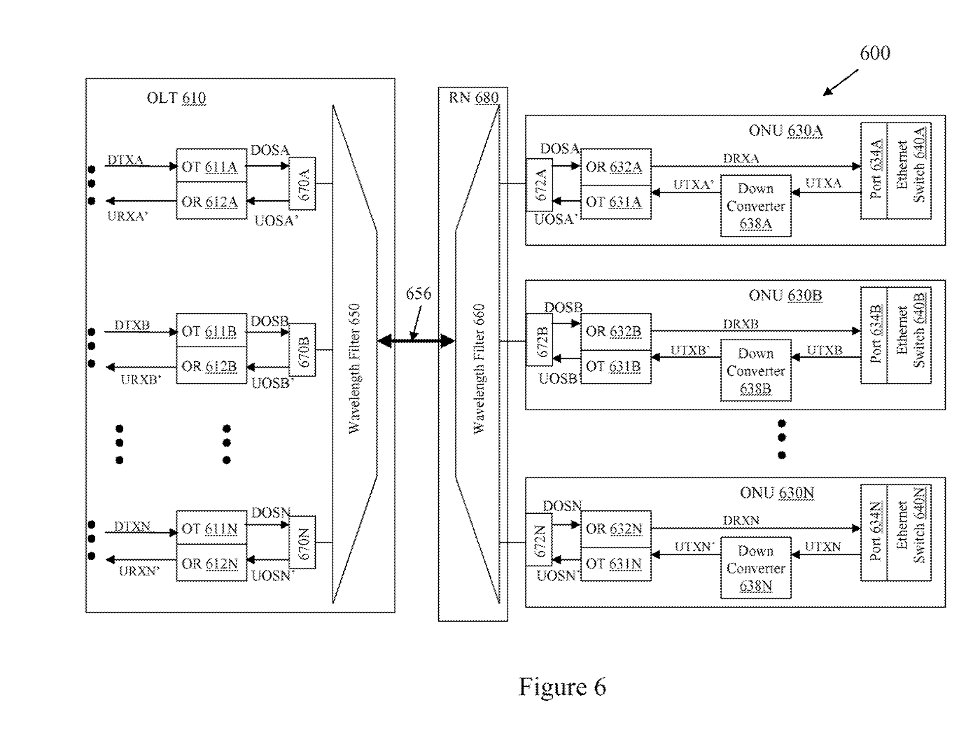

The asymmetric Ethernet systems 200 and 500 disclosed above can be readily implemented over a WDM-PON. Referring to FIG. 6, a WDM-PON optical Ethernet system 600 includes an OLT 610, a wavelength filter 660 at a remote node (RN) 680, and a plurality of ONUs 630A-630N. The OLT 610 includes a wavelength filter 650 that is connected with the wavelength filter 660 via optical fiber 656. The wavelength filter 650 can be based on an athermal arrayed waveguide grating (AWG). The wavelength filter 650 includes a plurality of optical ports that are respectively connected to a WDM-based signal combiner/separator 670A-670N. Each optical port occupies specific wavelength channels for either the downstream or the upstream traffic that are separated by one or multiple free spectral range (FSR) of the AWG. The detailed functions of the athermal AWG-based wavelength filter have been described in commonly assigned U.S. patent application Ser. No. 11/396,973, titled “Fiber-to-the-premise optical communication system”, filed Apr. 3, 2006, the disclosure of which is incorporated, herein by reference. The WDM-based signal combiner/separator 670A -670N separates the upstream optical signal UOSA′-UOSN′ to the respective optical receiver OR 612A-612N and simultaneously combines the downstream optical signal DOSA-DOSN from the respective optical transmitter OT 611A-611N to the common port that connects to a specific wavelength channel. For example, 670A receives downstream optical signals DOSA from OT 611A at the original baud rate (1.25 Gbps) and sends it to the wavelength filter 650 that further multiplex the optical signals from the other ports into the common port. Meanwhile, 670A demultiplexs upstream optical signals UOSA′ to OR 612A at a reduced baud rate (<1.25 Gbps), wherein OR 612A converts the upstream optical signal UOSA′ to an upstream electric signal URXA′ at the same reduced baud rate. An up-converter (not shown) can increase the baud rate of the upstream electric signal URXA′ to the original baud rate (1.25 Gbps). Ethernet switch and SerDes ports can be included to handle the downstream and upstream electric signals having the same baud rates, similar to the Ethernet-based optical network system 200 described above. The wavelength filter 650 can multiplex the downstream optical signals to the wavelength filter 660, and route upstream optical signals from the wavelength filter 660 to the appropriate port, which is further connected to a WDM-based signal combiner/separator 670A-670N respectively.

The wavelength filter 660 can be symmetrically constructed as the wavelength filter 650. The wavelength filter 660 can route down stream optical signals DOSA-DOSN to the ONUs 630A-630N in accordance with their wavelength channels. An ONUs 630A includes a WDM-based signal combiner/separator 672A and other components similar to ONU 230A in the Ethernet-based optical network system 200 as described above.

Regardless of the construction differences in the OLT, an abstraction of a WDM-PON is represented by multiple pairs of optical transmitter and receiver communicating within each individual WDM wavelength channels.

The present specification is described above with reference to exemplary embodiments. It will be apparent to those skilled in the art that various modifications may be made and other embodiments can be used without departing from the broader scope of the present specification. Therefore, these and other variations upon the exemplary embodiments are intended to be covered by the present specification.

It is understood that the specific configurations and parameters described above are meant to illustration the concept of the specification. The disclosed systems and methods can be compatible with variations of configurations and parameters without deviating from the spirit of the present invention. The optical line terminal in the disclosed systems can include any number of channels and be connected to any number of optical network units. The optical transmitter and the optical receiver at an optical network unit can be implemented integrated optical transceiver. Similarly, the optical transmitter and the optical receiver for a channel at an optical network unit can be implemented integrated optical transceiver.

The transmission baud rates for the upstream and down stream electric signals can be configured for any standard Ethernet at data rate of 10 Mbps, 100 Mbps, 1 Gbps, 10 Gbps, and so on; or for any non-standard Ethernet data rate of 2 Gbps, 3 Gbps, 4 Gbps, 5 Gbps, 6 Gbps, 7 Gbps, 8 Gbps and 9 Gbps etc. Different Ethernet ports of an optical line terminal in the disclosed system can have different transmission baud rates. For example, one port can be operated at baud rate of 1.25 Gbps; another port at 10.3125 Gbps; yet another port at a different band rate of 125 Mbps.

What is claimed is:

1. An Ethernet-based optical network system, comprising:
a first optical transmitter configured to receive a first electric signal and to produce a first optical signal;
a first optical receiver configured to convert the first optical signal to a second electric signal, wherein the first electric signal, the first optical signal, and the second electric signal have a first transmission baud rate;
a down converter configured to receive a third electric signal having the first transmission baud rate and to produce a fourth electric signal having a second transmission baud rate lower than the first transmission baud rate;
a second optical transmitter configured to receive the fourth electric signal and to produce a second optical signal having the second transmission baud rate;
a second optical receiver configured to convert the second optical signal to a fifth electric signal having the second transmission baud rate; and
an up converter configured to receive the fifth electric signal and to produce a sixth electric signal having the first transmission baud rate.

2. The Ethernet-based optical network system of claim 1, wherein the first optical transmitter, the second optical receiver, and the up converter are co-located at a first location.

3. The Ethernet-based optical network system of claim l, further comprising:
a first Ethernet switch configured to send the first electric signal to the first optical transmitter and to receive the sixth electric signal; and
a first serialization/deserialization port coupled to the first optical transmitter, the up converter, and the first Ethernet switch, wherein the first serialization/deserialization port is configured to serialize an egress electric signal from the first Ethernet switch to produce the first electric signal and to deserialize the sixth electric signal to produce an ingress electric signal to the first Ethernet switch.

4. The Ethernet-based optical network system of claim 3, wherein an input connection of the physical layer port in the first serialization/deserialization port is integrated with the up converter.

5. The Ethernet-based optical network system of claim 3, wherein the first serialization/deserialization port and the up converter are integrated in a unitary device.

6. The Ethernet-based optical network system of claim 1, further comprising:
a first wavelength filter coupled to the first optical transmitter and the second optical receiver; and
a second wavelength filter coupled to the first wavelength filter, the first optical receiver, and the second optical transmitter, wherein the first wavelength filter is configured to route the first optical signal to the second wavelength filter and the second wavelength filter is configured to route the first optical signal to the first optical receiver, wherein the second wavelength filter is configured to route the second optical signal to the first wavelength filter and the first wavelength filter is configured to route the second optical signal to the second optical receiver, wherein the first wavelength filter and the second wavelength filter is each configured to route optical signals in a plurality of wavelength channels.

7. The Ethernet-based optical network system of claim 6, wherein the first optical transmitter and the first optical receiver operate in the same wavelength channel.

8. The Ethernet-based optical network system of claim 6, wherein the second optical transmitter and the second optical receiver operate in the same wavelength channel.

9. The Ethernet-based optical network system of claim 1, wherein the first optical receiver, the second optical transmitter, and the down converter are co-located at a second location.

10. The Ethernet-based optical network system of claim 9, further comprising a second Ethernet switch/bridge having an egress port configured to receive the second electric signal and to send the third electric signal to the down converter.

11. The Ethernet-based optical network system of claim 10, further comprising a second serialization/deserialization port coupled to the first optical receiver, the down converter, and the second Ethernet switch/bridge, wherein the second serialization/deserialization port is configured to serialize an egress electric signal from the second Ethernet switch/bridge to produce the third electric signal for the down converter and deserialize the second electric signal from the first optical receiver to produce an ingress electric signal to the second Ethernet switch/bridge.

12. The Ethernet-based optical network system of claim 11, wherein an input connection of the physical layer port in the second serialization/deserialization port is integrated with the down converter.

13. The Ethernet-based optical network system of claim 12, wherein the second serialization/deserialization port and the down converter are integrated in a unitary device.

14. The Ethernet-based optical network system of claim 1, wherein the second transmission baud rate can be adjusted by one or more external control signals received by the down converter, the up converter, and the second Ethernet switch/bridge.

15. The Ethernet-based optical network system of claim 1, wherein the first transmission baud rate is selected from a group consisting of 10 Mbps, 100 Mbps, 1 Gbps, 2 Gbps, 4 Gbps, 5 Gbps, 10 Gbps, and 100 Gbps.

16. The Ethernet-based optical network system of claim 1, wherein the second transmission baud rate is in the range of less than the first transmission baud rate.

17. The Ethernet-based optical network system of claim 1, wherein the first optical transmitter comprises DFB laser, Fabre-Perot laser or wavelength tunable laser.

18. The Ethernet-based optical network system of claim 1, wherein the second optical transmitter comprises ASE source, a Fabre-Perot laser, a DFB laser or a wavelength tunable laser.

19. Art Ethernet-based optical network system, comprising:
a plurality of down converters each configured to receive a third electric signal having a first transmission baud rate and to produce a fourth electric signal having a second transmission baud rate lower than the first transmission baud rate;
a plurality of second optical transmitters each coupled to one of the down converters, wherein one of the second optical transmitters is configured to receive the fourth electric signal and to produce a second optical signal having the second transmission baud rate;
a plurality of second optical receivers each coupled to one of the second optical transmitters, wherein one of the second optical receivers is configured to convert the second optical signal to a fifth electric signal having the second transmission baud rate; and
an up converter coupled to the plurality of second optical receivers, wherein the up converter is configured to receive the fifth electric signal and to produce a sixth electric signal having the first transmission baud rate.

20. The Ethernet-based optical network system of claim 19, wherein each group of associated first optical transmitter, first optical receiver, second optical transmitter, and second optical receiver communicate in one of a plurality of wavelength channels.

21. The Ethernet-based optical network system of claim 19, further comprising:
a plurality of first optical transmitters, wherein one of the first optical transmitters is configured to receive a first electric signal and to produce a first optical signal; and
a plurality of first optical receivers each being coupled to one of the first optical transmitters, wherein one of the first optical receivers is configured to convert the first optical signal to a second electric signal, wherein the first electric signal, the first optical signal, and the second electric signal have the first transmission baud rate.

22. A method of communication in an Ethernet optical network, comprising:
receiving a first electric signal from a first Ethernet switch and producing a first optical signal by a first optical transmitter;
converting the first optical signal to a second electric signal by a first optical receiver, wherein the first electric signal, the first optical signal, and the second electric signal have a first transmission baud rate;
sending the second electric signal to a second Ethernet switch/bridge;
receiving a third electric signal from the second Ethernet switch/bridge and producing a fourth electric signal by a down converter, wherein the third electric signal has the first transmission baud rate and the fourth electric signal has a second transmission baud rate lower than the first transmission baud rate;
receiving the fourth electric signal and producing a second optical signal by a second optical transmitter, wherein the second optical signal has the second transmission baud rate;
converting the second optical signal to a fifth electric signal by a second optical receiver, wherein the fifth electric signal has the second transmission baud rate; and
receiving the fifth electric signal and producing a sixth electric signal by an up converter, wherein the sixth electric signal has the first transmission baud rate;
sending the sixth electric signal to the first Ethernet switch.

23. The method of claim 22, wherein the first optical transmitter, the second optical receiver, and the up converter are co-located at a first location.

24. The method of claim 22, wherein the first optical receiver, the second optical transmitter, and the down converter are co-located at a second location.

25. The method of claim 22, further comprising sending one or more control signals to the down converter and the up converter to adjust the second transmission baud rate.
